(19) United States
(12) Patent Application Publication
(10) Pub. No.: US 2009/0006987 A1
(43) Pub. Date: Jan. 1, 2009

(54) VISUAL DESIGN TOOLS FOR PORTAL CONTENT CREATION

(76) Inventors: Merav Simhi, Tel-Mond (IL); Galia Duchovny, Kiryat Eqron (IL); Ariel Tammmam, Ramat Hasharon (IL); Ran Gross, Rosh-Ha'ayin (IL); Adi Lavi, Zur Moshe (IL)

Correspondence Address: SAP AG c/o BUCKLEY, MASCHOFF & TALWALKAR LLC, 50 LOCUST AVENUE, NEW CANAAN, CT, 06840, US

(21) Appl. No.: 11/770,933

(22) Filed: Jun. 29, 2007

(51) Int. Cl. G06F 3/048

(52) U.S. Cl. 715/762

(57) ABSTRACT

According to some embodiments, meta-model rules associated with a business enterprise portal may be loaded. Portal content information may then be received from a user via a visual design tool executing in a design-time environment. The receiving may be performed, for example, in accordance with the meta-model rules.

### FIELD

Some embodiments of the present invention may relate to business information enterprise systems. In particular, some embodiments may comprise systems and methods wherein visual design tool may be used to create content for associated with an enterprise portal.

### BACKGROUND

A business information enterprise system may improve an organization's ability to monitor and/or manage data in a complex business environment. For example, such a system might store a large amount of business information, such as a yearly global sales plan and profit data on both a company-wide and regional basis. Different users may then access the information in different ways. For example, a business analyst might be interested in a normalized comparison of each years sales plan figures as compared to other years. A human resources administrator might instead want to access a list of employee names located in a particular country. In general, many different types of data could be stored by, and accessed from, a business information enterprise system (e.g., inventory data, sales data, and/or accounting data) and different types of data can often be used in different ways.

In some cases, business information is accessed through a Web-based “portal” that can display information to, and interact with, users. For example, a user might view business reports and/or select a particular item within a report to obtain further information about that item. Note that a user (or group of users) might want to customize the way in which information is displayed and/or interacted with via the portal.

To help a user design a personalized portal that suits his or her needs, a portal wizard or editor tool may store a pre-defined set of portal elements, such as portal templates and objects. The user could then arrange and further define the portal elements as required. Note that some or all of these portal elements may be associated with business logic. For example, a sales report template might be “built into” a wizard or portal editor tool such that a user will always see a particular graph when an item in a sales report is selected. Similarly, a particular type of portal element might be permitted in certain display areas (e.g., a human resources area within a portal page) while another type of portal element is not permitted in those areas.

Typically, a user needs to switch between the portal wizard or editor tool and another application while creating a portal (e.g., between the design-time application and a portal server to accomplish the creation of content). Such an approach, however, can be a complicated and time-consuming process for the user. Moreover, because different applications are involved, a graphical representation created by the user in one application may differ from what is actually rendered by the other application.

In addition, the source control and packaging associated with current approaches can be complex because more than one tool may involved with the creation of portal content. Another disadvantage of typical approaches is that the user and/or portal design tool must interact with an executing portal server while a user is defining and/or validating a portal layout. In some cases, however a user may want to design a business portal when an executing portal server is not currently available (e.g., when he or she is not communicating with a portal server).

Approaches that may improve a user's ability to design business information portals could, therefore, be desirable. Moreover, it may advantageous to provide one or more tools that facilitate a user's ability to do so in an efficient and convenient manner.

### BRIEF DESCRIPTION OF THE DRAWINGS

FIG. 1 is a block diagram of a system that may facilitate creation of business enterprise portal content according to some embodiments.

FIG. 2 is a flow diagram of portal content creation process steps pursuant to some embodiments.

FIG. 3 illustrates a data flow associated with creation of enterprise portal content according to some embodiments.

FIG. 4 is a more detailed data flow illustration associated with creation of enterprise portal content according to some embodiments.

FIG. 5 is a block diagram of an enterprise portal architecture according to some embodiments.

FIG. 6 is an enterprise portal layout environment layout display according to some embodiments.

FIG. 7 is an enterprise portal application modeling design display according to some embodiments.

FIG. 8 illustrates components of a portal design system according to some embodiments.

FIG. 9 is a block diagram of portal design components according to some embodiments.

FIG. 10 illustrates a system having a layout engine pursuant to some embodiments.

### DETAILED DESCRIPTION

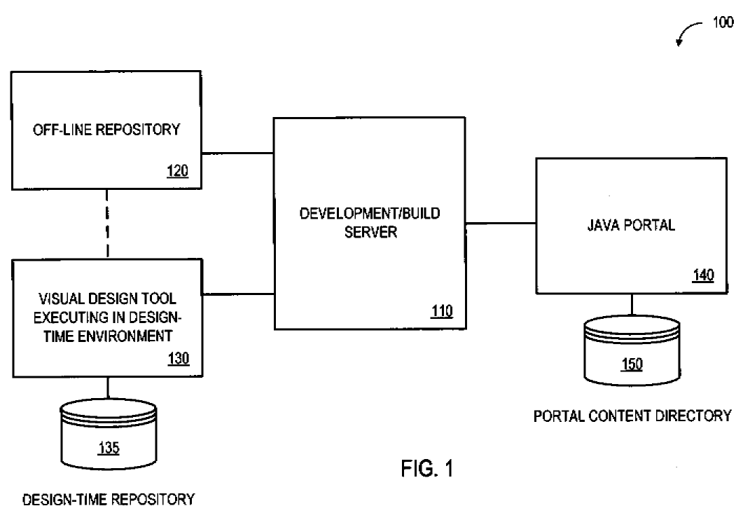

To alleviate problems inherent in the prior art, some embodiments of the present invention introduce systems, methods, computer program code, and means providing visual design tools to create portal content. For example, FIG. 1 is a block diagram of a system 100 that may facilitate creation and delivery of business enterprise portal content according to some embodiments. The system 100 includes a development/build server 110 that may receive information from an off-line repository 120.

The off-line repository 120 may comprise, for example, meta-model information associated with a portal content model. The meta-model information may have been created, for example, by a developer using a modeling tool. As used herein, the term “meta-model” may refer to, for example, information associated with an analysis, construction, and/or development of rules, constraints, and/or models applicable for a particular type of model.

According to some embodiments, the meta-model information includes rules and other information associated with portal templates and objects. The rules might include, for example, business logic (e.g., Java instructions on how certain business parameters should be calculated) and/or a set of user interface design rules (e.g., indicating how the tool should behave when a user drags or drops items within a portal layout).

According to some embodiments, meta-model information associated with enterprise portal content is defined by a user or developer with a Graphical User Interface (GUI) modeling tool. The portal content meta-model might be, for example, a set of Unified Modeling Language (UML) class diagram definitions holding the relations, attributes, and/or constraints of portal semantic objects which are independent of run-time or design-time environments.

The format of meta-model information may be transformed by the off-line repository 120 to create resources that can be used by the visual design tool and the development/build server 110. For example, the meta-model information may be provided, as XMI information, to a generic creator transformer. The generic creator transformer may then create templates that can be used as resources by the development/build server 110. Also the meta-model information may be provided to the visual design tool to indicate how the tool should behave when a user drags or drops items while creating the portal content.

The development/build server 110 and off-line repository 120 may exchange information via an interface (e.g., a local interface connection or a communication network interface). Note that elements described herein as communicating with one another may be directly or indirectly capable of communicating over any number of different systems for transferring data, including but not limited to shared memory communication, a local area network, a wide area network, a telephone network, a cellular network, a fiber-optic network, a satellite network, an infrared network, a radio frequency network, and any other type of network that may be used to transmit information between devices. Moreover, communication between systems may proceed over any one or more transmission protocols that are or become known, such as Asynchronous Transfer Mode (ATM), Internet Protocol (IP), Hypertext Transfer Protocol (HTTP), and/or Wireless Application Protocol (WAP), Although a single off-line repository 120 is illustrated in FIG. 1, note that any number of off-line repositories 120, as well as the other elements described herein, may be provided.

According to some embodiments, a visual design tool 130 executing in a design-time environment also provides information to the development/build server 110. The visual design tool 130 might be associated with, for example, the SAP™ Visual Composer and/or the Eclipse design tool. The visual design tool 130 might, for example, include an XGL compiler that provides XGL information to the development/build server 110. According to some embodiments, a design-time repository 135 may be used to save the model information, for example a model representation (“source representation”) of the particular portal layout and hierarchal structure for business information content. Also note that the visual design tool 130 might receive information from other sources, such as, for example, the off-line repository 120.

The visual design tool 130 might, for example, let a user or group of users define a particular portal layout and hierarchal structure for business information content. According to some embodiments, meta-model and configuration information associated with a portal is stored in the design time repository 135. Note that because the design time repository 135 may store meta-model information, the visual design tool 130 might not need to incorporate certain business logic information associated with the enterprise portal. That is, the business logic information may be “de-coupled” from a user interface of the visual design tool 130. Moreover, the portal content directory 150 may also act as a central, version-controlled repository for meta-model information (such as the views, pages, systems, and/or transport packages associated with a model or meta-model). While meta-model information may serve as an input to the visual design tool 130 in some embodiments, note that other information may by used by the visual design tool 130 to create fully structured portal content (e.g., role-based content) and/or a full set or tree of a portal object (e.g., with part of them views and pages and part of them structural objects such as folders and worksets).

The development/builder server 110 may include a portal generation engine that deploys portal information to a Java portal 140 (e.g., a Java Enterprise Edition portal). Moreover, information associated with portal content may be stored in a portal content directory 150.

According to some embodiments, the visual design tool 130 can also exchange information with the portal content directory 150. According to some embodiments, the interaction between the visual design tool 130 and the portal content directory 140 may be associated with a browse and/or search of a portal object.

The Java portal 140 might, for example, receive an HTTP portal request (e.g., including a Uniform Resource Locator (URL) address) from a users Web browser and access information from the portal content directory 150 to create a portal view that will be provided to the user. According to some embodiments, the Java portal 140 is associated with a portal run-time engine that is able to execute portal components and respond with Hypertext Markup Language (HTML) information produced by the components.

Note that some or all of the devices illustrated in FIG. 1 (as well as the other systems described herein) may use processor-executable program code read from one or more of a computer-readable medium, such as a floppy disk, a CD-ROM, a DVD-ROM, a magnetic tape, and a signal encoding the process, and then stored in a compressed, uncompiled and/or encrypted format. Note that embodiments are not limited to any specific combination of hardware and software. Moreover, the devices described herein might, for example, support any of the protocols in the following non-exhaustive list: Java Database Connectivity (JDBC), Java Connector (JCO), P4, and Simple Object Access Protocol (SOAP). Moreover, the databases might comprise a relational database accessible via a Structured Query Language (SQL) interface and/or systems which provide intermediary “business intelligence” to data stored within the database.

The user interfaces, such as the visual design tool 130 of FIG. 1, might execute at a workstation, Personal Computer, or a mobile wireless device, such as a laptop computer, a Personal Digital Assistant (PDA), a tablet computer, a handheld computer, or any other suitable devices that are or become known.

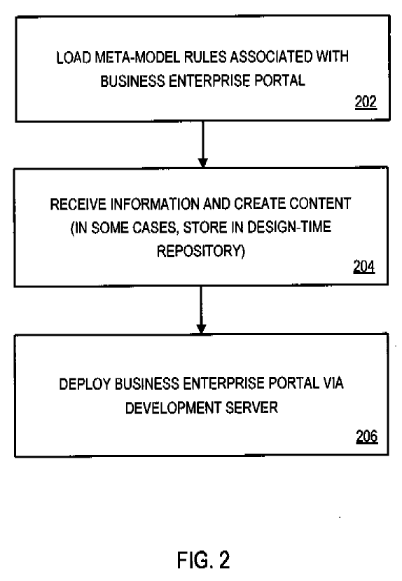

FIG. 2 is a flow diagram of process steps that might be associated with the system 100 of FIG. 1 pursuant to some embodiments. The flow charts described herein do not necessarily imply a fixed order to the actions, and embodiments may be performed in any order that is practicable. Note that any of the methods described herein may be performed by hardware, software (including microcode), firmware, or any combination of these approaches. For example, a storage medium may store thereon instructions that when executed by a machine result in performance according to any of the embodiments described herein.

At 202, meta-model rules associated with a business enterprise portal are loaded. The meta-model rules might comprise, for example, an abstract representation of model information (e.g., Extensible Markup Language (XML) information). Moreover, the meta-model rules may represent a persistent representation of information that is independent of a particular user interface and it's rendering technology (e.g., independent of the visualization layer of the portal design architecture). According to some embodiments, the meta-model rules are associated with portal objects and/or with relations defined between portal objects. For example, a meta-model rule might indicate that a particular type of portal element is not allowed to be added to a particular type of portal area or to another type of portal element.

At 204, information may be received and content may be created. For example, portal content information may be received via a visual design tool executing in a design-time environment. Moreover, the portal content information may be received in accordance with the meta-model rules. For example, a user might (or might not) be allowed to drag and drop a particular type of portal element to a particular portal area or location (that represents another portal object) in accordance with the applicable meta-model rule. According to some embodiments, the portal content is received via a “plug-in” or “kit” that is associated with the visual design tool. The content created at 204 might be associated with, for example, XGL and/or GML data. According to some embodiments, the created content is stored in a design-time repository, such as the design-time repository 134 described with respect to FIG. 1.

At 206, the business enterprise portal may be deployed via a development server. For example, after a user has defined all of the content associated with a portal, information may be deployed via a development server. Note that if the resulting portal is not what the user expected, the portal content may be modified and re-deployed (replacing the previous version). According to some embodiments, information may be deployed by invoking a portal runtime provider via the visual design tool. Portal configuration data may then be compiled to XML information and information associated with the XML information may be packed as part of an enterprise archive. The enterprise archive can then be deployed to create portal content.

According to some embodiments, a visual representation of portal content associated with the visual design tool has a pre-determined relationship with a visual representation of portal content associated with the business enterprise portal that is actually delivered. That is, the visual design tool may provide a “what-you-see-is-what-you-get” rendering of the portal as it is being developed by the user.

Thus, a user may create portal information in a composition environment without needing to switch between design-time and portal execution applications. Moreover, modeled content in the visual design tool may behave like actual content in an executing portal. In addition, the users may generate content using any modeling tool and the architecture is robust (in that future changes in input/output formants and environment can be handled) and the source control and packaging associated with some embodiments may be improved because fewer tools are involved with the creation of portal content.

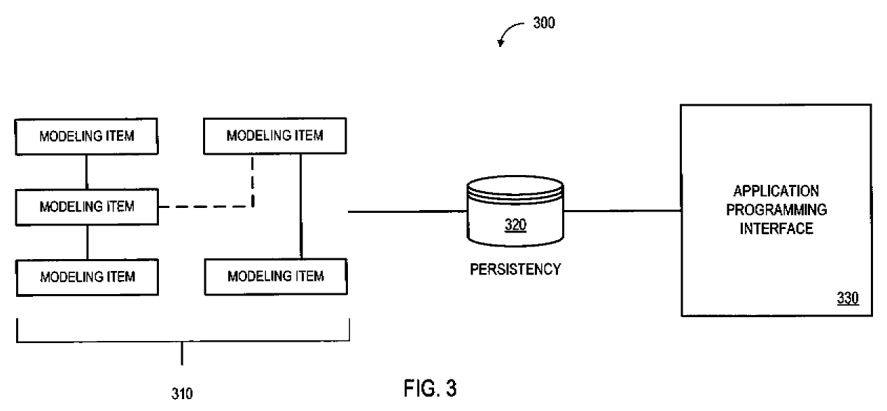

FIG. 3 illustrates a data flow 300 associated with creation of enterprise portal content according to some embodiments. Initially, model and meta-model information 310 may be defined (e.g., including information about a set of modeling items and relationships between the modeling items). Note that the meta-model information 310 might be generated using any modeling tool. According to some embodiments, the meta-model information is associated with UML models and/or “diagrams,” As used herein, a “diagram” may refer to, for example, a partial graphical representation of a system's model. The model may also contain semantic information, such as use cases that drive the model elements and diagrams.

Embodiments may be associated with, for example, a functional model (associated with the functionality of the system from the users point of view), an object model (associated with the structure and substructure of the system using objects, attributes, operations, and relationships), and/or a dynamic model (associated with the internal behavior of the system), Examples of models and diagrams might include, for example, structure diagrams, class diagrams, component diagrams, composite structure diagrams, deployment diagrams, object diagrams, package diagrams, behavior diagrams, activity diagrams, state machine diagrams, use case diagrams, interaction diagrams, communication diagrams, sequence diagrams, permission diagrams, and/or timing diagrams. Although meta-model information 310 is described herein by way of example, note that embodiments might be associated with other types of information.

The model and meta-model information might include, for example, relations, inheritances, and/or semantics creation. According to some embodiments, some or all of this information may be exported and saved to a persistency database 320, such as one associated with a source control repository, portal content directory or file system. As used herein, a “persistency database” may refer to, for example, a database having the ability to retain data structures between program executions. This might be achieved, for example, by storing the date in non-volatile storage such as a file system or a relational database or an object database. One example of persistence is using Java serialization to store Java objects on disk or using Java to store enterprise Java information in a relational database.

According to some embodiments, an Application Programming Interface (API) 330 exposes the information in the persistency database 320 during run-time. As used here, an API may refer to, for example, a source code interface that a computer system or program library provides to support requests for services to be made of it by a computer program. The API 330 may, for example, be specified in terms of a programming language that can be compiled when an application is built and may represent a coherent interface consisting of several classes or several sets of related functions or procedures.

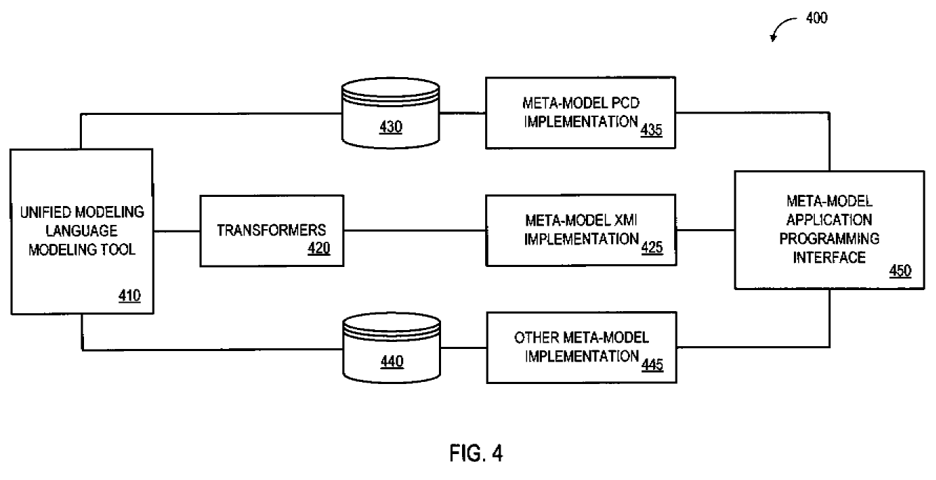

FIG. 4 is a more detailed data flow 400 illustration associated with providing the required Meta data input for the creation of enterprise portal content according to some embodiments. In particular, a UML modeling tool 410 may be associated with any standardized specification language for object modeling. According to some embodiments, the UML modeling tool 410 is associated with a general-purpose modeling language that includes a graphical notation used to create an abstract model of a system, referred to as a UML model. Moreover, the UML modeling tool 410 may be associated with business processing models as defined by the Object Management Group (OMG) and/or a Meta-Object Facility (MOF) meta-model.

The UML modeling tool 410 may export information using, for example, XML Metadata Interchange (XMI) information. The use of XMI information, may, for example, enable interchange of metadata between UML-based modeling tools and MOF-based metadata repositories in distributed heterogeneous environments. The XMI information may also be used as the medium by which models are passed from modeling tools to software generation tools. According to some embodiments, the UML modeling tool 410 might be associated with the Rational Rose software application. Note that, in cases where UML might not be appropriate, complex constraints might instead be defined using an Object Constraint Language (OCL) information. Although meta-model information is described herein by way of example, note that embodiments might be associated with other types of information.

The UML modeling tool 410 might, for example, provide XMI information to one or more transformers 420. According to some embodiments, the transformers 420 might provide, for example Generic Creator (GC) script to a meta-model repository 430, such as a portal content directory or the off-line repository 120 of FIG. 1. According to other embodiments, the UML modeling tool 410 might provide XMI information to another centralized modeling infrastructure database 440 instead of, or in addition to, the meta-model repository 430.

The elements of FIG. 4 discussed above may be associated with, for example, a developer environment of the portal system. The remaining element now described may be associated with, for example, a “design time” environment associated with the portal content. In particular, a meta-model XMI implementation 425 might directly provide information to a meta-model API 450. In other cases, a meta-model portal content directory implementation 435 might receive information from the meta-model repository 430 and provide information to the meta-model API 450. In still other cases, another meta-model implementation 445 may receive information from a centralized modeling infrastructure database 440 and provide information to the meta-model API 450.

In this way, the data flow 400 may provide portal semantics and templates along with the attributes (e.g., a name, description, and/or creator) and meta-attributes (e.g., whether data is a string, integer, or array) of entities. According to some embodiments, the attribute information may be layered and/or categorized. In addition, the data flow 400 may provide relation information (roles, cardinality, constraints), an ability to instantiate objects, information about existing objects, and/or extensions of a basic model (“scenarios”). Note that because the data flow 400 can define scenarios for portal content creation in design-time tools (e.g., sets of objects, templates, and/or relations that extends and/or adds constraints on a basic scenario), content creation may be provided using off-line tools. Moreover, a generic API for content creation may be s provided and may enable creation of content without direct reference to content types and provide a common modeling infrastructure (e.g., by providing generic tools for all content types without each object type needing its own transport handler).

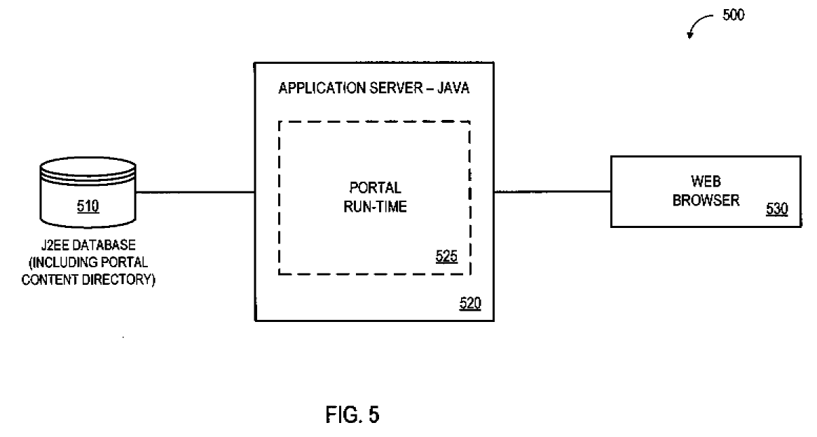

FIG. 5 is a block diagram of an enterprise portal architecture 500 according to some embodiments. The architecture 500 includes a Java application server 520 that accesses a Java Platform Enterprise Edition (J2EE) database 510 with a portal content directory. The application server 520 may, for example, be a programming platform for developing and running distributed multi-tier architecture applications, and may be based on modular software components running on the application server 520. The application server 520 may include, for example, a portal run-time 525 that lets a developer create an enterprise portal that is portable between platforms and scalable, while integrating with legacy technologies. According to some embodiments, the application server 520 handles the transactions, security, scalability, concurrency and management of the components that are deployed to it. Thus, when a Web browser 530 requests a particular portal page, the application server 520 and executing portal run-time 525 can access information in the J2EE database 510 to retrieve and provide the appropriate content.

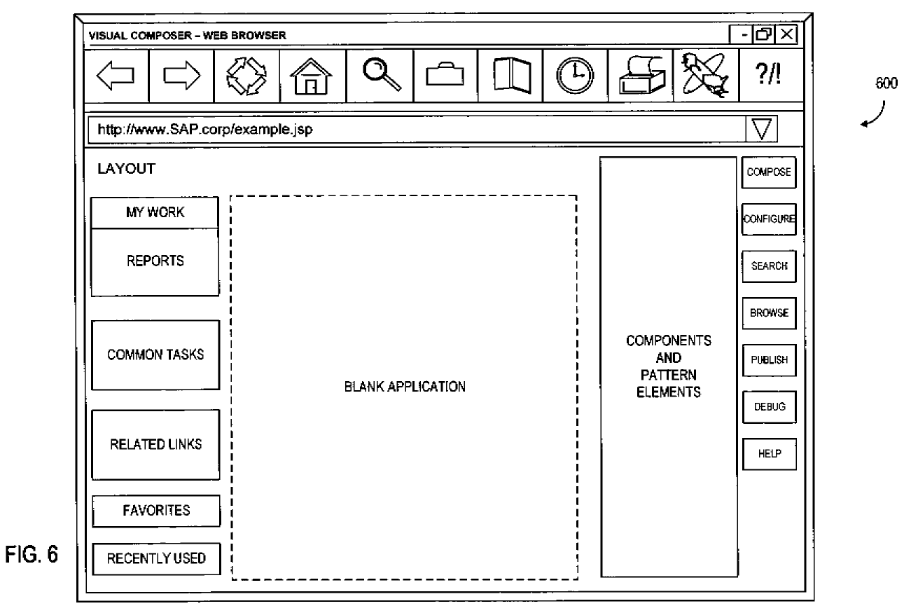

FIG. 6 is an enterprise portal work environment layout display 600 according to some embodiments. The layout display 600 might, for example, be used by a business analyst to define and configure a portal content hierarchal structure (typically a tree of portal objects grouped under a role or a worksets which are collection of portal content views that could be assigned to a user) for his or her customized enterprise portal where it is laid out similar to the layout of that content runtime representation in the actual runtime portal. According to some embodiments, the layout display 600 is associated with the SAP™ Visual Composer tool that facilitates the creation of content for a business portal using modeling capabilities and a visual User Interface (UI) rather than manually writing code. Such an approach may provide tools for creating role based content including hierarchical (tree) structure of portal content elements that comprise from structural objects (i.e. folder containing portal views), portal views that process data from back-end systems, including local and third-party enterprise systems and respective navigation flows between those views. According to some embodiments, the layout display 600 is a Web-based application that lets users (or sets of users) build or customize complete portal content structures (typically tree of portal objects) that comprise of roles/worksets (a set of portal objects hierarchy organized) pages and portal views as needed. Note that the layout display 600 may, in addition to modeling pages, be associated with modeling any portal semantic, including a role, work-center, or view. Also, according to some embodiments, a portal navigation structure and associated applications to a modeling portal semantic element might be represented here.

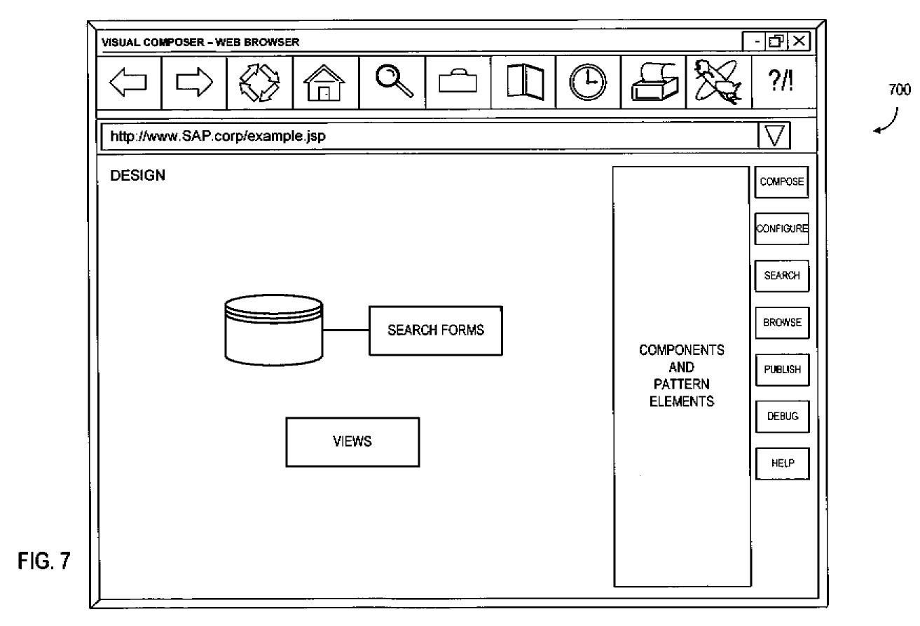

FIG. 7 is an enterprise portal application modeling design display 700 according to some embodiments. Such a display 700 might, for example, let a user define portal content that was laid out in connection with the display of FIG. 6. The design display 700 might, for example, let a user compose information by allowing him or her to perform freestyle or pattern modeling of a new portal component (e.g., a scenario, service, process, or module) or pattern element. The design display 700 might also let a user configure, organize, and search information, publish portal content and/or debug information being defined by the user. Note that content defined by the displays 600, 700 might be provided to different run-time application to render results (e.g., Flex or Ajax applications). Moreover, the abilities provided via the displays 600, 700 might let portal objects and visual composer components be re-used to improve the efficiency of the portal design process.

The displays 600, 700 may, for example, let a user “compose” portal information using a shape selector (e.g., tabs, views, and/or trees), general elements (e.g., portal views, groups, and/or links), pattern elements, layout patterns (e.g., two side-by-side areas or one above another), containers (panels, tab strips, and wizards), portal semantics (e.g., iViews, pages, worksets, roles, and/or workcenters) and/or interactors (e.g., form, grid, tile, list, chart, tree, HTML, and/or nested views). Other functions available via the displays 600, 700 might include the ability to search and browse for information, to publish portal information, and/or to debug potential portal information. The portal information defined by a user could include, by way of example only, common tasks, related links, favorites, recently used information, his or her work reports, and/or a blank application yet to be fully defined by the user. The displays 600, 700 may let a user combine portal components and provide a “what you see is what you get” UI.

According to some embodiments, the displays 600, 700 are implemented via a plug-in kit for a visual design tool. Moreover, the visual design tool may load portal meta-model rules and layout template resources that define, for example, where and when a user is allowed to drag and drop a portal role component from a palette to other areas of the displays 600, 700. When a component is added, a GUI modeling language portal object may be created as a re-usable component based on meta-model relations.

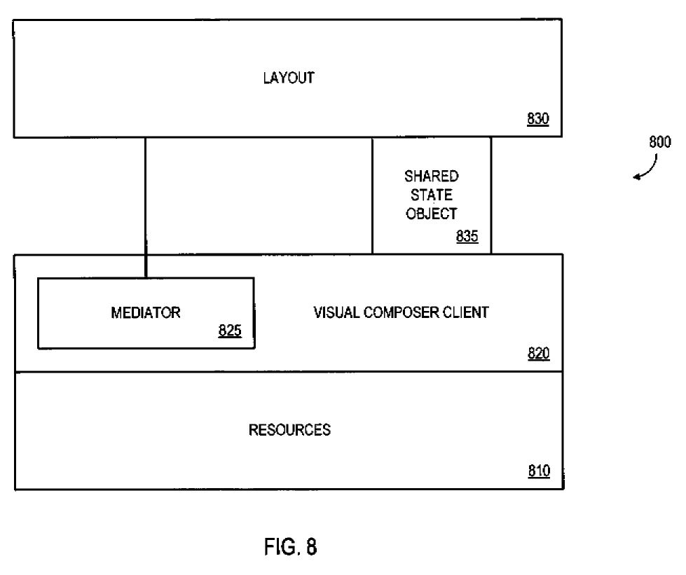

FIG. 8 illustrates components of a portal design system 800 according to some embodiments. The system includes a layout component 830 associated with a visualization layer. The layout component 830 may be independent of a persistent representation of portal information and may receive portal content information via a GUI (e.g., by interfacing with a user via a display 600 such as the one illustrated in FIG. 6).

A visual composer client 820 (e.g., associated with a visual design tool component) may exchange information with the layout component 830 via a shared state object 835. The shared state object 835 may comprise, for example, a shared XML state object. According to some embodiments, the visual composer client 820 includes a mediator 825 to bridge the layout component 830 with a persistent representation of portal content information. Note that the mediator 825 might be associated with a plug-in or kit associated with the visual composer client 820.

By way of example, the mediator 825 might write information to the shared state object 835 and a “what-you-see-is-what-you-get” portion of the layout component 830 might read that information from the shared state object 835. The mediator 825 may also exchange information with the layout component 830 by invoking APIs and/or synchronization events.

The mediator 825 might also exchange information with other elements by invoking APIs and/or synchronization events. For example, the visual composer client 820 may include a rule manager and/or meta-model component, wherein the mediator 825 controls the visualization layer based at least in part on information received from the meta-model component. For example, the visual composer client 820 may receive from resources 810 meta-model XML information (e.g., transformed from XMI) along with layout templates associated with the kit (e.g., representing the types of content that can be part of a portal page or view). Note that each specific kit might hold a pre-defined layout XML template which the mediator 825 can then fill with instance data.

By way of example, a user might try to drag and drop an object to a particular location via the layout component 830 (e.g., using the display 600 of FIG. 6). The layout component 830 might then ask the mediator 825 if such an action is appropriate. The mediator 825, in turn, might determine if the action is appropriate based on meta-model rules (e.g., received from the resources 810). For example, it might to be appropriate to let a user place a portal folder object in a portal report location. If appropriate, the mediator 825 and layout component 830 let the user place the object in that location (e.g., and a new GUI modeling language object may be created for the user). According to some embodiments, a specific kit for the visual composer client 820 may include rules that over-ride generic rules provided by the meta-model from the resources 810.

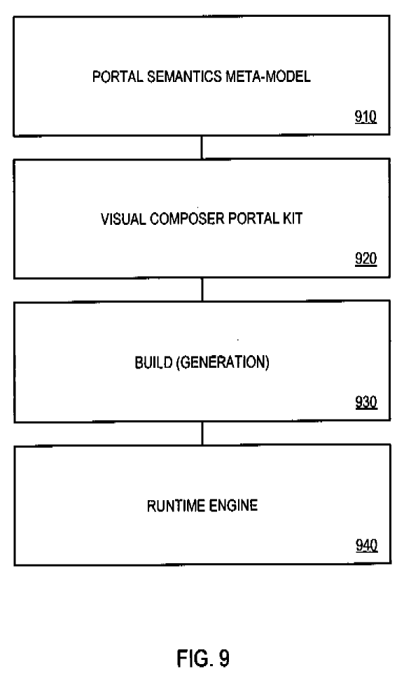

FIG. 9 is a block diagram of portal design components according to some embodiments. In particular, a visual composer portal kit 920 may receive meta-model information from a portal semantics meta-model 910. The metal-model information might include, for example, rules and/or relationships indicating which portal components are allowed to be dragged into which portal containers or objects. Such metal-model rules might be received, for example, by a GUI modeling language portal model in the visual composer portal kit 920. The GUI modeling language portal model might further include portal content model and/or portal template driven rules as well as rules internal to the portal kit. Note that models might be saved, for example, in a design-time repository such as the design-time repository 135 described with respect to FIG. 1.

According to some embodiments, the visual composer portal kit 920 is also be associated with portal model XML information and/or GUI modeling language information that is provided to a build (generation) component 930 that includes a portal generator. For example, a visual design tool component might send XML information associated with portal content to a build portal generator.

Finally, information may be provided from the build (generation) component 930 to a runtime engine 940. For example, to a Portal Content Directory (PCD) of the runtime engine 940 that might receive the information. Note that the portal semantics meta-model 910, the visual composer portal kit 920, and/or the build/generation component 930 may be associated with a development infrastructure. According to some embodiments, the PCD might not be source controlled. That is, the PCD might act as a run-time database (and the modeled content tree may be stored in a source control database such as a design-time repository).

Note that, according to some embodiments, the build process associated with portal content creation may be layered such that an abstraction layer is provided to receive model data from model persistency, communicate information via a portal content model API, and create an output abstractly. In this way, specific media (such as XGL or Generic Creator) may be de-coupled to enable plugging information associated with different formats as appropriate.

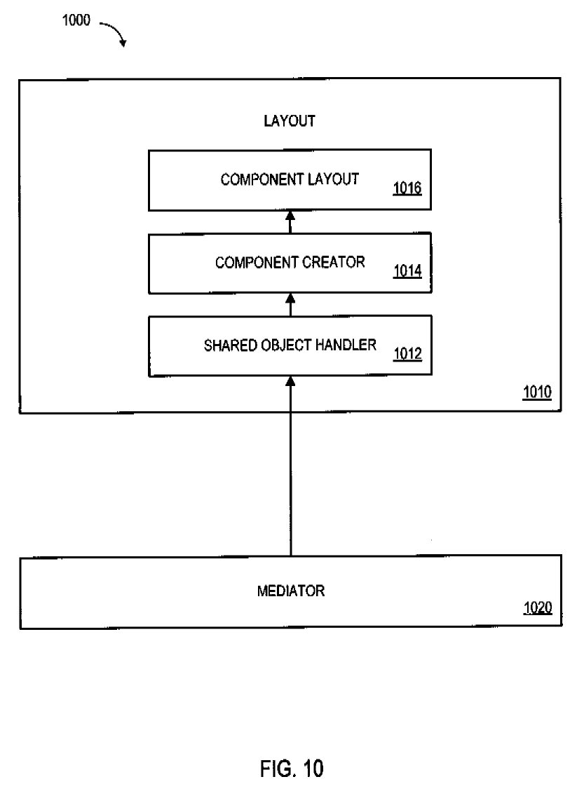

FIG. 10 illustrates a system 1000 having a layout engine or component 1010 pursuant to some embodiments. The layout engine 1010 may, for example, exchange information with a mediator 1020 (e.g., associated with a portal modeling infrastructure kit). In particular, a shared object handler 1020 of the layout engine 1010 may receive, extract, and/or filter data from the mediator 1020 via state APIs of a shared object.

A component creator portion 1014 of the layout engine 1010 may create layout objects, update the layout object's properties, and/or delete layout objects when required. A component layout portion 1016 of the layout engine 1010 may create a layout grid, populate the grid with components, and/or manage the content of the area layout. According to some embodiments, the layout engine 1010 also includes layout components and user interface components.

Thus, embodiments may provide for portal content creation that can be done without the need to switch between design-time tools and a portal application. Such an approach may provide a user with a less complicate design environment as well as “what-you-see-is-what-you-get” capabilities. By integrating portal content creation as a kit for a visual design tool, a user may view content being packaged and a generic solution may be provided to describe portal objects and relationships between them.

The following illustrates various additional embodiments. These do not constitute a definition of all possible embodiments, and those skilled in the art will understand that many other embodiments are possible. Further, although the following embodiments are briefly described for clarity, those skilled in the art will understand how to make any changes, if necessary, to the above description to accommodate these and other embodiments and applications.

For example, although embodiments have been described as being used to develop a business information portal, embodiments may be used with respect to other types of portals. Moreover, although particular types of modeling and meta-modeling languages and specifications have been described, embodiments may be associated with any other type of appropriate languages and specifications.

The several embodiments described herein are solely for the purpose of illustration. Persons skilled in the art will recognize from this description other embodiments may be practiced with modifications and alterations limited only by the claims.

What is claimed is:

1. A method associated with a business enterprise portal, comprising:
loading meta-model rules associated with the business enterprise portal; and
receiving portal content information from a user via a visual design tool executing in a design-time environment, said receiving being performed in accordance with the meta-model rules.

2. The method of claim 1 wherein the meta-model rules are associated with at least one of: (i) portal objects, or (ii) relations defined between portal objects.

3. The method of claim 1, wherein the visual design tool is associated with a visualization layer and the meta-model rules are associated with a persistent representation of information.

4. The method of claim 1, wherein said receiving is performed in accordance with at least one of: (i) a plug-in associated with the visual design tool, or (ii) a kit associated with the visual design tool.

5. The method of claim 1, further comprising:
deploying the business enterprise portal via a development server.

6. The method of claim 5, wherein said deploying comprises:
invoking a portal runtime provider via the visual design tool;
compiling portal configuration data to extensible markup language information;
packing information associated with the extensible markup language information as part of an enterprise archive; and
deploying the enterprise archive to create portal content.

7. The method of claim 1, wherein a visual representation of portal content associated with the visual design tool has a pre-determined relationship with a visual representation of portal content associated with the business enterprise portal deployed to the development server.

8. The method of claim 1, further comprising:
generating preview information associated with the business enterprise portal; and
displaying the preview information to a portal designer.

9. A portal modeling system, comprising:
a layout component associated with a visualization layer, the layout component to receive, from a user, portal content information via a graphical user interface; and
a visual design tool component to exchange information with the layout component via a shared state object.

10. The portal modeling system of claim 9, wherein the visual design tool component includes:
a mediator to bridge the layout component with a persistent representation of portal content information.

11. The portal modeling system of claim 10, wherein the mediator exchanges information with the layout component via an application programming interface.

12. The portal modeling system of claim 10, further comprising: a meta-model component, wherein the mediator controls the visualization layer based at least in part on information received from the meta-model component.

13. The portal modeling system of claim 10, wherein the layout component includes at least one of, (i) a component layout portion, (ii) a component creator portion, or (iii) a shared object handler portion.

14. The portal modeling system of claim 10, wherein the mediator is associated with at least one of: (i) a plug-in associated with the visual design tool component, or (ii) a kit associated with the visual design tool component.

15. The portal modeling system of claim 14, wherein a visual design tool component kit is associated with a graphical user interface modeling language portal model.

16. The portal modeling system of claim 14, wherein the visual design tool component outputs extensible markup language information associated with portal content to a build portal generator.

17. A computer-readable medium storing processor-executable process steps associated with a business information portal, the process steps comprising:
loading meta-model rules associated with the business information portal; and
receiving portal content data from a user via a visual tool executing in a design-time environment, said receiving being performed in accordance with the meta-model rules.

18. The medium of claim 17, wherein the receiving is performed in accordance with at least one of: (i) a plug-in associated with the visual tool, or (ii) a kit associated with the visual tool.

19. The medium of claim 18, wherein the meta-model rules are associated with at least one of: (i) portal objects, or (ii) relations defined between portal objects.

20. The medium of claim 19, wherein the visual tool is associated with a visualization layer and the meta-model rules are associated with a persistent representation of information.

21. The medium of claim 20, wherein the process steps further comprise deploying the business enterprise portal via a development server.
